(19) United States
(12) Patent Application Publication
(10) Pub. No.: US 2026/0202338 A1
(43) Pub. Date: Jul. 16, 2026

(54) SPECTROSCOPIC SYSTEMS

(71) Applicant: 908 Devices Inc., Boston, MA (US)

(72) Inventors: David W. Schiering, Danbury, CT (US); Gregg Ressler, Shelton, CT (US); Charles D. Conaty, Norwalk, CT (US)

(21) Appl. No.: 19/447,454

(22) Filed: Jan. 13, 2026

Related U.S. Application Data
(60) Provisional application No. 63/744,823, filed on Jan. 13, 2025.

(51) Int. Cl. G01N 21/65; G01N 21/64

(52) U.S. Cl. CPC G01N 21/65; G01N 21/645; G01N 2021/6463

(57) ABSTRACT

Optical elements include a capture element having cylindrical symmetry with respect to a central axis of the capture element and featuring an outer surface formed as a surface of revolution about the central axis, a coupling element that contacts the capture element and includes a central axis that is collinear with the central axis of the capture element, and a mask disposed on or adjacent to a surface of the capture element, and featuring a plurality of apertures that define entrance and exit apertures for radiation into and out of the optical element, where the capture element, coupling element, and mask are configured to define two different optical excitation pathways in the optical element through two different apertures of the plurality of apertures, and where the two different optical excitation pathways end at a common location at a surface of the coupling element.

### CROSS-REFERENCE TO RELATED APPLICATIONS

This application claims priority to U.S. Provisional Application No. 63/744,823, filed on Jan. 13, 2025, the entire contents of which are incorporated herein by reference.

### TECHNICAL FIELD

This disclosure relates to spectroscopic methods and systems, and measurement of spectroscopic information from samples.

### BACKGROUND

Raman spectroscopy and infrared absorption/reflectance spectroscopy are well known techniques for characterizing a variety of materials. Each technique effectively elucidates vibrational information from a sample, but the mechanism by which the sample response arises is different in each, and consequently, the nature of the information provided by each technique differs. Moreover, due to the underlying differences in mechanism, the optical systems used to induce and measure sample responses via these mechanisms can differ significantly.

### SUMMARY

The systems, methods, and apparatus described herein include components and steps for making both infrared absorption/reflectance spectroscopic measurements and Raman spectroscopic measurements from a common portion of a sample. The components can include a coupling element featuring one or more reflective surfaces for reflecting incident radiation to generate an output waveform that is perturbed via evanescent coupling through the one or more reflective surfaces to the sample. Typically, such components can also include one or more transmissive surfaces for introducing excitation radiation into a sample and/or admitting radiation that is generated in, transmitted through, and/or reflected from the sample. In this manner, the components allow for different types of interaction between incident radiation and a sample to occur, such that different types of sample information can be measured. For example, sample responses induced by different types of excitation (such as different optical spectroscopic modalities) can be measured and used to elucidate information about a sample.

The systems, methods, and apparatus described herein permit a variety of different combinations of sample responses to be measured. For example, by employing the coupling elements described, two or more different types of sample optical responses can be investigated. Examples of optical mechanisms that can be interrogated include sample absorbance, sample reflectance, Raman scattering, light scattering, nonlinear optical interactions (e.g., frequency generation and downconversion), higher order (e.g., 3^{rd} order and higher) optical responses (e.g., optical Kerr effect, four-wave mixing), and sample emission (e.g., fluorescence, luminescence, phosphorescence).

By using a common coupling element through which incident radiation that induces different sample responses is introduced, each of the sample responses can be measured from a common portion of the sample. This can be particularly advantageous in circumstances where the sample structure may be non-homogeneous, where the sample structure is time-varying, and/or when the sample is flowing or being translated. In each of these circumstances, conventional measurements of different sample responses are typically performed on different portions of a sample. Consequently, variations in the nature of the portion of the sample that is being probed may manifest as differences in the observed sample responses - differences that would not otherwise be expected if the same portion of the sample was probed in each instance. By using a common coupling element, such sources of error can be reduced and/or eliminated, and the amount of the sample that is consumed when making measurements can also be reduced.

In a first aspect, the disclosure features optical elements that include a capture element having cylindrical symmetry with respect to a central axis of the capture element and featuring an outer surface formed as a surface of revolution about the central axis, a coupling element that contacts the capture element and includes a central axis that is collinear with the central axis of the capture element, and a mask disposed on or adjacent to a surface of the capture element, and featuring a plurality of apertures that define entrance and exit apertures for radiation into and out of the optical element, where the capture element, coupling element, and mask are configured to define two different optical excitation pathways in the optical element through two different apertures of the plurality of apertures, and where the two different optical excitation pathways end at a common location at a surface of the coupling element.

Embodiments of the optical elements can include any one or more of the following features.

The capture element can be formed as a truncated cone. The surface of revolution that forms the outer surface of the capture element can be a linear surface. The surface of revolution that forms the outer surface can include a plurality of linear segments. The surface of revolution that forms the outer surface can include a curved surface. The curved surface can have a parabolic curvature, a hyperbolic curvature, a spherical curvature, and/or an elliptical curvature.

The surface of revolution that forms the outer surface can include a curved surface portion and at least one linear surface portion. The curved surface portion and the at least one linear surface portion can form a contiguous surface of revolution. The curved surface can have a compound curvature formed by a plurality of curved surface regions of different curvature.

The capture element can be formed from at least one material selected from the group consisting of: diamond, silicon, germanium, zinc selenide, zinc sulfide, glass, quartz, potassium iodide, potassium bromide, calcium fluoride, sodium chloride, sodium fluoride, barium fluoride, cesium iodide, cesium bromide, thallium bromide, thallium iodide, and TlBrₓI₁₋ₓ, wherein x is in a range between 0 and 1.

The coupling element can include an outer surface, and the outer surfaces of the capture element and the contact element can form a contiguous outer surface of the optical element. The coupling element can be symmetric about the central axis of the coupling element. The coupling element can include an outer surface formed from a plurality of planar surface segments arranged symmetrically about the central axis of the coupling element. The coupling element can be a prism.

The coupling element can include an outer surface formed as a surface of revolution about the central axis of the coupling element. The surface of revolution that forms the outer surface of the coupling element can be a linear surface. The surface of revolution that forms the outer surface of the coupling element can include a plurality of linear segments. The surface of revolution that forms the outer surface of the coupling element can include a curved surface. The curved surface of the outer surface of the coupling element can have a parabolic curvature, a hyperbolic curvature, a spherical curvature, and/or an elliptical curvature.

The surface of revolution that forms the outer surface of the coupling element can include a curved surface portion and at least one linear surface portion. The curved surface portion and the at least one linear surface portion of the surface of revolution that forms the outer surface of the coupling element can form a contiguous surface of revolution. The curved surface of the surface of revolution that forms the outer surface of the coupling element can have a compound curvature formed by a plurality of curved surface regions of different curvature.

The coupling element can be formed from at least one material selected from the group consisting of: diamond, silicon, germanium, zinc selenide, zinc sulfide, glass, quartz, potassium iodide, potassium bromide, calcium fluoride, sodium chloride, sodium fluoride, barium fluoride, cesium bromide, cesium iodide, thallium bromide, thallium iodide, and TlBrₓI₁₋ₓ, wherein x is in a range between 0 and 1.

The mask can be positioned on or adjacent to a surface of the capture element that is opposite to a surface of the capture element that contacts the coupling element. The mask can define a first aperture and first optical path for illumination light within the optical element, and the central axis of capture element may not be within (i.e., can be outside) the first aperture. The first aperture can be positioned so that illumination light propagating along the first optical path in a direction parallel to the central axis of the capture element will be incident on the outer surface of the capture element from within the capture element.

The mask can define a second aperture and second optical path for illumination light within the optical element, and the central axis of the capture element can be within the second aperture. The second aperture can be positioned so that illumination light propagating along the second optical path in a direction parallel to the central axis of the capture element will not be incident on the outer surface of the capture element from within the capture element. The second aperture can be positioned so that illumination light propagating along the second optical path in a direction parallel to the central axis of the capture element will be incident on an interface between the capture element and the coupling element.

The coupling element can include a contact surface positioned opposite a surface of the coupling element that contacts the capture element, and the second aperture can be positioned so that illumination light propagating along the second optical path in a direction parallel to the central axis of the capture element will be incident on the contact surface. The second aperture can be positioned so that light emitted from a sample that contacts the contact surface of the coupling element emerges from the optical element through the second aperture.

The mask can define a third aperture and third optical path for reflected light within the optical element, and the central axis of the capture element may not be within (i.e., can be outside) the third aperture. The third aperture can be positioned so that light reflected from the contact surface of the coupling element and from the outer surface of the capture element emerges from the optical element through the third aperture.

The first and third apertures can have a common shape in a plane defined by the surface of the capture element on which or adjacent to which the mask is disposed. The first, second, and third apertures can have a common shape in a plane defined by the surface of the capture element on which or adjacent to which the mask is disposed. The first and third apertures can be a common, ring-shaped aperture that is symmetric about the central axis of the capture element. At least one of the first and third apertures can be an arc-shaped aperture. A center of curvature of the arc-shaped aperture can coincide with a center of the surface of the capture element on which or adjacent to which the mask is disposed. The central axis of the capture element can extend through the center of curvature of the arc-shaped aperture. The central axis of the capture element can extend through a center of the second aperture.

The second aperture can be symmetric about the central axis of the capture element. The second aperture can be circular in shape. The optical elements can include a reflective coating positioned on at least a portion of the outer surface of the capture element. The optical elements can include an anti-reflection coating positioned between the mask and the surface of the capture element on which the mask is disposed or to which the mask is adjacent. The anti-reflection coating can include a plurality of dielectric material layers. The anti-reflection coating can include a first coating material having a first anti-reflection spectral band, positioned so that the first coating material is aligned with at least one of the plurality of apertures, and a second coating material having a second anti-reflection spectral band that is different from the first anti-reflection spectral band, and positioned so that the second coating material is aligned with a different at least one of the plurality of apertures.

The optical elements can include a reflective surface positioned at an interface between the capture element and the coupling element. The reflective surface can include a reflective coating disposed on at least one of a surface of the capture element and a surface of the coupling element. The reflective surface may not extend fully across the interface between the capture element and the coupling element. The reflective surface can define a fourth aperture positioned so that illumination light that reflects from the outer surface of the capture element is not incident on the reflective surface. The reflective surface can define a fifth aperture positioned so that illumination light that propagates along the central axis of the capture element is not incident on the reflective surface. The reflective surface can be positioned so that illumination light that reflects from a surface of the coupling element that is opposite to the interface also reflects from the reflective surface. The reflective surface can be positioned so that illumination light reflects multiple times from the surface of the coupling element that is opposite to the interface and from the reflective surface.

The optical elements can include a recess formed in a surface of the capture element. The recess may not extend fully across the interface between the capture element and the coupling element. The recess can define a fourth aperture positioned so that illumination light that reflects from the outer surface of the capture element enters the coupling element without being incident on the recess. The recess can define a fifth aperture positioned so that illumination light that propagates along the central axis of the capture element passes through the recess. The recess can be positioned so that illumination light reflects multiple times from the surface of the coupling element that is opposite to the interface and from the surface of the coupling element that contacts the capture element.

Embodiments of the optical elements can also include any of the other features described herein, and can include any combinations of features that are described in connection with different examples, except as expressly stated otherwise.

In another aspect, the disclosure features measurement systems that include any of the optical elements described herein, a first radiation source, a second radiation source, a first detector, and a second detector, where the optical element is positioned relative to the first and second radiation sources such that during operation of the measurement system, when the optical element is in contact with a sample: the first radiation source generates first incident radiation that enters the optical element through a first aperture of the plurality of apertures and is incident at a location on the sample; the second radiation source generates second incident radiation that enters the optical element through a second aperture of the plurality of apertures and is incident at the location on the sample; the first detector is positioned to receive first emitted radiation through a third aperture of the plurality of apertures in response to an interaction between the sample and the first incident radiation; and the second detector is positioned to receive second emitted radiation through the second aperture in response to an interaction between the sample and the second incident radiation.

Embodiments of the measurement systems can include any one or more of the following features.

The first radiation source can be configured to generate first incident radiation that is at least partially absorbed by the sample. The second radiation source can be configured to generate second incident radiation that induces the sample to emit the second emitted radiation. The second incident radiation can induce the sample to emit scattered light as the second emitted radiation. The scattered light can include Raman scattered light. The second incident radiation can induce the sample to emit fluorescence as the second emitted radiation.

The second radiation source can be configured to generate the second incident radiation with a full-width at half-maximum (FWHM) spectral bandwidth of 10 nm or less. The second radiation source can be configured to generate the second incident radiation with a central wavelength of between 200 nm and 1600 nm.

The first radiation source can be configured to generate the first incident radiation with a full-width at half-maximum (FWHM) spectral bandwidth of 10 nm or more. The first radiation source can be configured to generate the first incident radiation with a central wavelength of between 600 nm and 50,000 nm.

The first radiation source can include an interferometer. The first detector can be configured to spectrally resolve the first emitted radiation. The second detector can be configured to spectrally resolve the second emitted radiation.

Embodiments of the measurement systems can also include any of the other features described herein, and can include any combinations of features that are described in connection with different examples, except as expressly stated otherwise.

In a further aspect, the disclosure features sample measurement methods that include directing first incident radiation through any of the optical elements described herein to be incident at a location on a sample and measuring first emitted radiation generated in response to the first incident radiation and emerging from the optical element, and directing second incident radiation through the optical element to be incident at the location on the sample and measuring second emitted radiation generated in response to the second incident radiation and emerging from the optical element, where the first emitted radiation includes first incident radiation reflected from a surface of the optical element in contact with the sample, and where the second emitted radiation includes radiation emitted from the sample through the surface of the optical element.

Embodiments of the methods can include any one or more of the following features.

The first incident radiation can be at least partially absorbed by the sample. The second incident radiation can induce the sample to emit the second emitted radiation. The second incident radiation can induce the sample to emit scattered light as the second emitted radiation. The scattered light can include Raman scattered light. The second incident radiation can induce the sample to emit fluorescence as the second emitted radiation.

The second incident radiation can have a full-width at half-maximum (FWHM) spectral bandwidth of 10 nm or less. The second incident radiation can have a central wavelength of between 200 nm and 1600 nm.

The first incident radiation can have a full-width at half-maximum (FWHM) spectral bandwidth of 10 nm or more. The first incident radiation can have a central wavelength of between 600 nm and 50,000 nm.

Measuring the first emitted radiation can include spectrally resolving the first emitted radiation. Measuring the second emitted radiation can include spectrally resolving the second emitted radiation.

Embodiments of the methods can also include any of the other steps and features described herein, and can include any combinations of steps and features that are described in connection with different examples, except as expressly stated otherwise.

In another aspect, the disclosure features optical elements that include a first planar surface configured to contact a sample, a second planar surface opposite the first planar surface, a first lateral surface oriented at an angle to the first and second planar surfaces, a second lateral surface oriented at an angle to the first and second planar surfaces, and an anti-reflection coating disposed on at least a portion of the second planar surface.

Embodiments of the optical elements can include any one or more of the following features.

The optical element can be formed as a truncated prism. The optical element can be formed as a truncated cone. The optical element can include a central axis about which the optical element is symmetric. The optical element can be rotationally symmetric about the central axis. The optical element can include an outer surface formed as a surface of revolution about the central axis. The surface of revolution that forms the outer surface of the capture element can be a linear surface. The surface of revolution that forms the outer surface can include a plurality of linear segments. The surface of revolution that forms the outer surface can include a curved surface. The curved surface can have a parabolic curvature, a hyperbolic curvature, a spherical curvature, and/or an elliptical curvature.

The surface of revolution that forms the outer surface can include a curved surface portion and at least one linear surface portion. The curved surface portion and the at least one linear surface portion can form a contiguous surface of revolution. The curved surface portion can have a compound curvature formed by a plurality of curved surface regions of different curvature.

The optical element can be formed from at least one material selected from the group consisting of: diamond, silicon, germanium, zinc selenide, zinc sulfide, glass, quartz, potassium iodide, potassium bromide, calcium fluoride, sodium chloride, sodium fluoride, barium fluoride, cesium bromide, cesium iodide, thallium bromide, thallium iodide, and TlBrₓI₁₋ₓ, wherein x is in a range between 0 and 1. The anti-reflection coating can include a plurality of dielectric material layers.

Embodiments of the optical elements can also include any other features described herein, and can include any combinations of features that are described in connection with different examples, except as expressly stated otherwise.

In a further aspect, the disclosure features measurement systems that include any of the optical elements described herein, a first radiation source, a second radiation source, a first detector, and a second detector, wherein the optical element is positioned relative to the first and second radiation sources such that during operation of the measurement system, when the optical element is in contact with a sample: the first radiation source generates first incident radiation that enters the optical element through the first lateral surface and is incident at a location on the sample; the second radiation source generates second incident radiation that enters the optical element through the second planar surface and is incident at the location on the sample; the first detector is positioned to receive first emitted radiation through the second lateral surface in response to an interaction between the sample and the first incident radiation; and the second detector is positioned to receive second emitted radiation through the second planar surface in response to an interaction between the sample and the second incident radiation.

Embodiments of the measurement systems can include any one or more of the following features.

The first radiation source can be configured to generate first incident radiation that is at least partially absorbed by the sample. The second radiation source can be configured to generate second incident radiation that induces the sample to emit the second emitted radiation. The second incident radiation can induce the sample to emit scattered light as the second emitted radiation. The scattered light can include Raman scattered light. The second incident radiation can induce the sample to emit fluorescence as the second emitted radiation.

The second radiation source can be configured to generate the second incident radiation with a full-width at half-maximum (FWHM) spectral bandwidth of 10 nm or less. The second radiation source can be configured to generate the second incident radiation with a central wavelength of between 200 nm and 1600 nm. The first radiation source can be configured to generate the first incident radiation with a full-width at half-maximum (FWHM) spectral bandwidth of 10 nm or more. The first radiation source can be configured to generate the first incident radiation with a central wavelength of between 600 nm and 50,000 nm.

The first radiation source can include an interferometer. The first detector can be configured to spectrally resolve the first emitted radiation. The second detector can be configured to spectrally resolve the second emitted radiation.

Embodiments of the measurement systems can also include any other features described herein, and can include any combinations of features that are described in connection with different examples, except as expressly stated otherwise.

In another aspect, the disclosure features sample measurement methods that include directing first incident radiation through the first lateral surface of any of the optical elements described herein to be incident at a location on a sample and measuring first emitted radiation generated in response to the first incident radiation and emerging from the second lateral surface of the optical element, and directing second incident radiation through the optical element to be incident at the location on the sample and measuring second emitted radiation generated in response to the second incident radiation and emerging from the optical element through the second planar surface, where the first emitted radiation includes first incident radiation reflected from the first planar surface of the optical element in contact with the sample, and where the second emitted radiation includes radiation emitted from the sample through the first planar surface of the optical element.

Embodiments of the methods can include any one or more of the following features.

The first incident radiation can be at least partially absorbed by the sample. The second incident radiation can induce the sample to emit the second emitted radiation. The second incident radiation can induce the sample to emit scattered light as the second emitted radiation. The scattered light can include Raman scattered light. The second incident radiation can induce the sample to emit fluorescence as the second emitted radiation.

The second incident radiation can have a full-width at half-maximum (FWHM) spectral bandwidth of 10 nm or less. The second incident radiation can have a central wavelength of between 200 nm and 1600 nm.

The first incident radiation can have a full-width at half-maximum (FWHM) spectral bandwidth of 10 nm or more. The first incident radiation can have a central wavelength of between 600 nm and 50,000 nm.

Measuring the first emitted radiation can include spectrally resolving the first emitted radiation. Measuring the second emitted radiation can include spectrally resolving the second emitted radiation.

Embodiments of the methods can also include any of the other steps and features described herein, and can include any combinations of steps and features that are described in connection with different examples, except as expressly stated otherwise.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the subject matter herein, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments are set forth in the accompanying drawings and the description below. Other features and advantages will be apparent from the description, drawings, and claims.

### DESCRIPTION OF DRAWINGS

FIG. 1 is a schematic diagram showing an example of a measurement system.

FIG. 2A is a schematic diagram of an example of an optical element.

FIG. 2B is a schematic diagram of an example of a capture element.

FIG. 2C is a schematic diagram of another example of a capture element.

FIG. 2D is a schematic diagram of another example of a capture element.

FIG. 2E is a schematic diagram of another example of a capture element.

FIG. 3 is a schematic diagram showing an example anti-reflection coating on an optical element.

FIG. 4 is a schematic diagram showing an example mask on an optical element.

FIG. 5 is a schematic diagram of another example of an optical element.

FIG. 6A is a schematic diagram a further example of an optical element.

FIG. 6B is a sectional view of the example optical element of FIG. 6A.

FIG. 7 is a schematic diagram of another example of an optical element.

FIG. 8 is a schematic diagram of another example of an optical element.

Like reference symbols in the various drawings indicate like elements.

### DETAILED DESCRIPTION

Spectroscopic methods have been used to characterize a wide variety of structural features of samples, and it has been recognized that different types of spectroscopic techniques provide complementary information about a sample. The complementary information can be cooperatively assessed to provide a more complete characterization of the sample structure than would otherwise be possible by considering only one type of sample information. Spectroscopic techniques have been developed for probing many sample features including, but not limited to, vibrational structure, rotational structure, electronic structure, conformational structure, defect presence, structural rearrangements and conversions, and more complex dynamic responses to a variety of external stimuli. Spectroscopic methods that interrogate such sample features include infrared vibrational spectroscopy, ultraviolet and/or visible absorption/transmission spectroscopy, Raman scattering spectroscopy, light scattering spectroscopy, nonlinear optical spectroscopy (including, for example, various harmonic generation, down-conversion, and mixing processes), multiphoton absorption/emission spectroscopy, more complex high order nonlinear optical spectroscopic techniques (e.g., 3^{rd} order, 5^{th} order, 7^{th} order mixing techniques, for example), and emission spectroscopy (e.g., fluorescence emission, luminescence, and/or phosphorescence emission).

Furthermore, the various spectroscopic techniques can be performed in different regions of the electromagnetic (EM) spectrum to elucidate sample information. For example, infrared absorbance/reflectance spectroscopy can be used to probe sample responses in the near-IR, mid-IR, and/or far-IR regions of the EM spectrum. Absorbance/reflectance spectroscopy can also be performed in the ultraviolet, visible, and/or microwave regions of the EM spectrum. Emission spectroscopy can also be performed in the ultraviolet, visible, infrared, and even longer-wavelength portions of the EM spectrum. In general, the wavelength region probed correlates with the optical mechanism underlying the spectroscopic technique, and therefore, with a particular type of sample response.

By way of example only, the following discussion will focus on methods, systems, and apparatus used to measure spectroscopic information about a sample using two different spectroscopic techniques: infrared absorption/reflection, and Raman scattering. However, it should be understood that the methods, systems, and apparatus are not limited to these examples, and generally, can be used to measure information from a sample using many different combinations of techniques, including any of those mentioned herein. Moreover, the methods, systems, and apparatus are not limited to measuring information from a sample using only two spectroscopic methods. To the contrary, combinations of two, three, four, five, and even more than five different spectroscopic methods can be used to measure sample information, and the combination can include any one or more of the different techniques described herein. Some or all of the techniques can be implemented using components such as the coupling elements that are described in more detail below.

Both infrared absorbance/reflectance and Raman scattering provide information that can be used to characterize different aspects of vibrational and structural properties of a sample. The information provided by each technique independently can be used to determine an identity of a sample of unknown composition. Considered together, infrared absorbance/reflectance and Raman scattering information typically enables enhanced elucidation of structural information for an unknown sample.

Both infrared absorbance/reflectance and Raman scattering measurements provide information about transitions between vibrational energy states in a sample. However, the nature of the transitions that are probed by each technique differs. Consequently, depending upon the type of sample, one technique or the other may provide more useful information in some circumstances. For some samples, the information provided by one technique may be sufficient to arrive at an identification of the sample, and the information provided by the other technique may effectively provide a check on the validity of any identification. For other samples, information obtained from both types of spectroscopy may be needed to arrive at a provisional sample identification. For still other samples, the information from both techniques, even when combined, may be insufficient to identify the sample. In some circumstances, information from additional spectroscopic (and/or non-spectroscopic) techniques can be used to resolve such insufficiencies.

Systems that measure infrared absorbance/reflectance information for a sample are commercially available, as are systems that separately measure Raman scattering information. When a sample is interrogated sequentially using these separate measurement systems, infrared absorbance/reflectance information and Raman scattering information are typically measured from different portions of the sample. This inconsistency can arise for a variety of reasons: it can be difficult to align the sample precisely with the spatial location that is effectively probed by each instrument; the sample may be flowing or undergoing translation; the sample may have structural inhomogeneity on a spatial scale that is smaller than the practical resolution to which the sample can be aligned in each instrument; and the sample may undergo structural or other changes during measurement that make it necessary to expose unperturbed regions of the sample each time a new measurement is initiated. As a result, infrared absorbance/reflectance measurements and Raman scattering measurements are typically obtained with separate measurement systems from different portions of a sample and the measurement information is analyzed separately.

The methods, systems, and apparatus described herein allow multiple different types of spectroscopic information to be obtained from a sample by probing a common location of the sample with different spectroscopic techniques. The combination of techniques is achieved by using one or more coupling elements that allow for different optical excitations of the sample to occur at a common location, and/or for radiation emitted from the common location of the sample (according to different mechanisms) to be admitted into the coupling elements and directed to an optical apparatus of analysis.

Infrared absorbance/reflectance spectroscopy can be performed in various measurement configurations. In some embodiments, the measurement configuration is an attenuated total reflection (ATR) geometry in which incident radiation reflects from a surface that is in contact with, or in close proximity to, a sample. The incident radiation interacts with the sample via evanescent coupling through the surface and the resulting interaction perturbs the incident radiation, which undergoes (nominally) total reflection from the surface. The reflected radiation is detected and analyzed, and the perturbations relative to the initial radiation provide information about the nature of the sample. In certain embodiments, ATR measurement configurations use a coupling element with a surface that causes total internal reflection of the incident radiation within the element. A variety of different materials can be used to fabricate such an element. Due to the relatively high index of refraction necessary for total internal reflection in such an element, common materials include diamond, silicon, germanium, ZnSe, ZnS, and TlBrₓI₍₁₋ₓ₎ (where x=0 . . . 1).

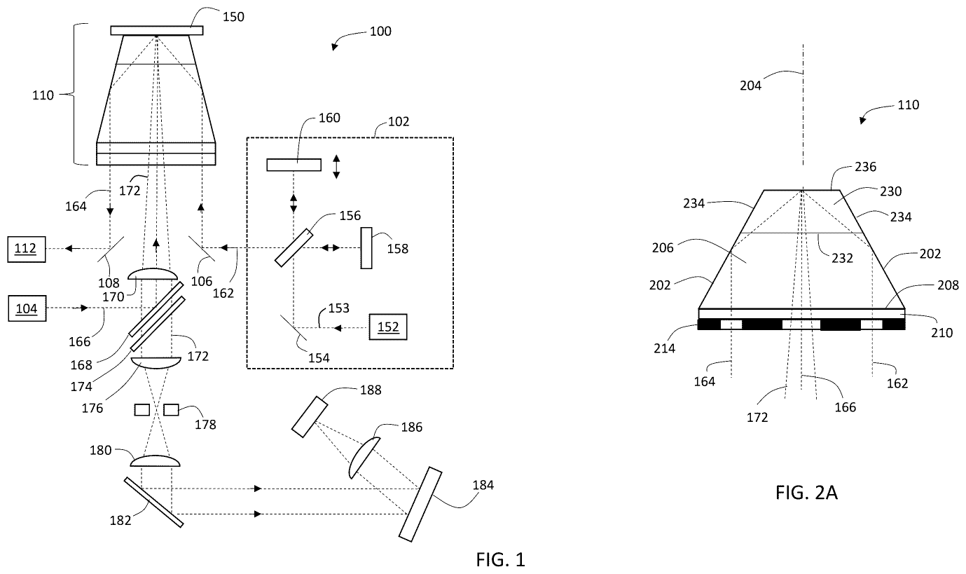

FIG. 1 is a schematic diagram showing an example of a system 100 that obtains both infrared absorbance/reflectance information and Raman scattering information for a sample. System 100 includes a first radiation source 102. In the example shown in FIG. 1, first radiation source 102 generates infrared radiation for obtaining infrared absorbance/reflectance measurements for a sample.

First radiation source 102 can generally be implemented in many ways. In some embodiments, for example, first radiation source 102 includes one or more diodes, lasers, lamps, or other emitting elements that generate incident light for transmission to a sample. In general, first radiation source 102 can also include a wide variety of optical elements including, but not limited to, lenses, mirrors, beam splitters, filters, prisms and/or other dispersive elements, phase-modulating elements, and harmonic conversion elements.

It should be noted that the implementation of first radiation source 102 shown in FIG. 1 is merely an example, and first radiation source 102 can generally be implemented in configurations that are different from that example. In the specific example of FIG. 1, radiation source 102 is implemented as an interferometric radiation source. First radiation source 102 includes a light source 152 that generates radiation 153. Radiation 153 is reflected by mirror 154 and is incident on beam splitter 156. A first portion of radiation 153 is reflected by beam splitter 156 and is incident on fixed mirror 158. This first portion of radiation 153 is reflected by fixed mirror 158 back to beam splitter 156.

A second portion of radiation 153 is transmitted through beam splitter 156 and is incident on movable mirror 160. The position of mirror 160 relative to beam splitter 156 along the optical path of the second portion of radiation 153 is adjustable. As such, the optical path length traversed by the second portion of radiation 153 can be varied, in contrast to the optical path length traversed by the first portion of radiation 153 which remains fixed. The second portion of radiation 153 is reflected from movable mirror 160 toward beam splitter 156.

At beam splitter 156, a portion of the reflected radiation from fixed mirror 158 is transmitted through beam splitter 156. Also at beam splitter 156, a portion of the reflected radiation from movable mirror 160 is reflected by beam splitter 156 and overlaps spatially with the portion of the reflected radiation from fixed mirror 158 that is transmitted through beam splitter 156, forming incident radiation 162. Depending upon the relative path difference between the radiation reflected from mirrors 158 and 160 in incident radiation 162, the radiation from mirrors 158 and 160 interferes, modulating the intensity and/or phase of incident radiation 162. Control over the position of movable mirror 160 relative to beam splitter 156 allows the modulation induced by interference to be carefully controlled, and in turn, allows control over incident radiation 162.

Incident radiation 162 is directed by mirror 106 into a coupling element 110, which is positioned in contact with, or in close proximity to, a sample 150. The incident radiation 162 interacts with the sample while remaining internal to coupling element 110, and reflected radiation 164 emerges from coupling element 110. Reflected radiation 164, encoded with sample information (e.g., spectral information such as absorption information) based on the interaction between the radiation and sample 150, is directed by mirror 108 to be incident on a detector 112. The sample information encoded in reflected radiation 164 and arising from the interaction with sample 150 is measured by detector 112.

Detector 112 can generally be implemented as any one or more of a variety of different detectors or detector elements. Examples of suitable detectors that can be used include, but are not limited to, photodiode-based detectors, photomultiplier tubes, spectrally-resolving detectors (e.g., spectrometers), CMOS-based detectors, and CCD-based detectors. Other examples of suitable detectors include photoconductive detectors, pyroelectric detectors, photovoltaic detectors, and bolometric detectors.

In the example shown in FIG. 1, system 100 also includes a second radiation source 104. Second radiation source 104 can be implemented in different forms. In some embodiments, for example, second radiation source 104 includes a laser. In certain embodiments, second radiation source 104 includes one or more laser diodes. In some embodiments, second radiation source 104 includes one or more light emitting diodes. In certain embodiments, second radiation source includes a flash lamp, a halide lamp, or an incandescent light source. Other light sources can also be present in second radiation source 104, as can combinations of the above source types.

Second radiation source 104 generates incident radiation 166, which is reflected by mirror 168 through focusing lens 170 and into coupling element 110. The incident radiation 166 passes through coupling element 110 and is incident on sample 150.

In response to excitation by incident radiation 166, sample 150 generates emitted radiation 172. Emitted radiation 172 can be generated in sample 150 according to different mechanisms, as mentioned above. In the example shown in FIG. 1, incident radiation 166 undergoes Raman scattering in sample 150, and emitted radiation 172 corresponds to Raman scattered incident radiation. More generally, however, emitted radiation 172 is generated by sample 150 in response to incident radiation 166 according to any of a variety of different mechanisms, and can therefore correspond to absorption, reflection, or transmission of incident radiation by the sample, scattering of incident radiation by the sample, a nonlinear optical process induced in the sample by incident radiation, and/or emission of radiation in response to incident radiation (e.g., fluorescence emission, luminescence, and/or phosphorescence emission).

The emitted radiation is transmitted out of coupling element 110 along the optical path of incident radiation 166, passing through collimating lens 170 and mirror 168. In the example shown in FIG. 1, mirror 168 is implemented as a dichroic mirror that reflects radiation in a wavelength band of incident radiation 166 and transmits radiation in a wavelength band of emitted radiation 172. Alternatively, in some embodiments, mirror 168 includes an aperture through which emitted radiation 172 passes after emerging from coupling element 110 and passing through collimating lens 170. As another alternative, in certain embodiments, emitted radiation 172 emerges from coupling element 110 along an optical path that is displaced from the optical path of incident radiation 166, and bypasses mirror 168 after passing through collimating lens 170.

Emitted radiation 172 is transmitted through an optional filter 174 in FIG. 1. Filter 174 can be used, for example, to filter out stray incident radiation and/or to reduce or eliminate radiation in wavelength bands that do not correspond to a desired wavelength band for the emitted radiation from the sample. Radiation in spectral regions that do not correspond to the desired wavelength band can arise from other processes that occur in the sample in response to exposure to incident radiation 166 (e.g., Rayleigh scattering of the incident radiation).

The filtered emitted radiation 172 is focused by lens 176 through an aperture 178, recollimated by lens 180, and directed by mirror 182 to a spectrally resolved detector. In the example shown in FIG. 1, the spectrally resolved detector includes a dispersive grating 184 that disperses wavelength components of emitted radiation 172 spatially. The dispersed wavelength components are focused by lens 186 to an array detector 188. Array detector 188 can be implemented as a CCD-based detector, a CMOS-based detector, an array of diodes, or any other type of multi-channel detector.

In system 100, coupling element 110 allows incident radiation from multiple sources to interact with sample 150 to induce different sample responses and allow for the measurement of different types of sample information. In the specific example shown in FIG. 1, coupling element 110 allows incident radiation to be delivered to sample 150 to obtain both infrared reflectance information and Raman scattering information. In general, coupling element 110 can be implemented in a variety of configurations to implement this functionality.

As noted above, the systems, methods, and devices described herein can be used to direct different types of incident radiation to a common location in a sample and/or to detect radiation emitted from, reflected from, or otherwise emerging from, the common location. As used herein, directing different radiation sources (i.e., radiation beams, or more generally, distributions) to a “common location” refers to causing the radiation generated by the different radiation sources to be incident on a surface of a sample (or alternatively, at a location on a surface of a coupling element) such that the radiation is at least partially spatially overlapped at the surface. Similarly, measuring different radiation that emerges from the sample at a common location refers to measuring radiation that is at least partially spatially overlapped as it leaves the sample through a sample surface.

In practice, the “common location” on the sample surface or surface of the coupling element can be a point location, or can be a region of relatively small dimension. For example, for two or more distributions of incident radiation that are incident on a surface of a sample or coupling element, each with a local maximum intensity point, the two or more distributions are incident at a “common location” if the local intensity maxima of each of the distributions are displaced from one another by no more than 10 microns. Similarly, for two or more distributions of radiation emerging from the sample, the two or more distributions emerge from a “common location” if the local intensity maxima of each of the distributions are displaced from another by no more than 10 microns.

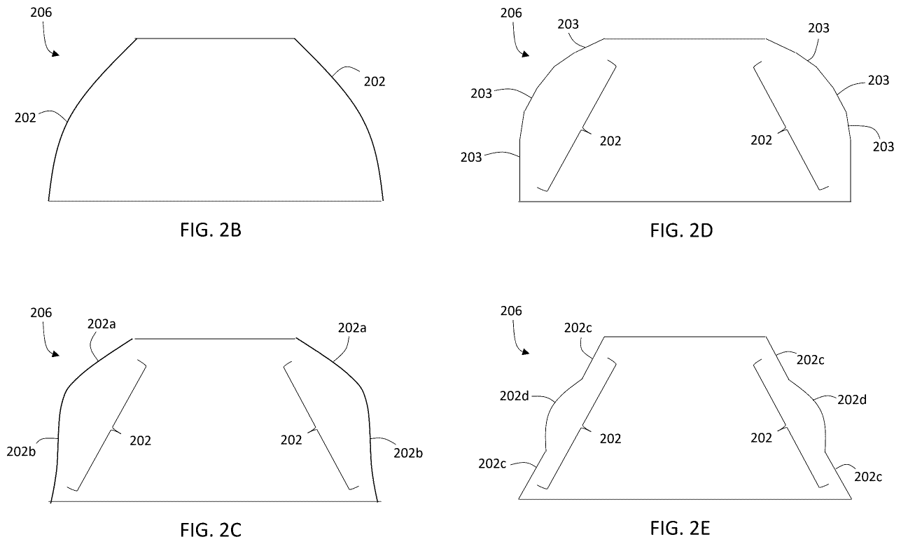

FIG. 2A is a schematic diagram showing an example of a coupling element 110. Coupling element 110 is generally formed from two components: a capture element 206 and a contact element 230. Capture element 206 includes an upper surface that contacts a lower surface of contact element 230, forming an interface 232 between the two elements.

Capture element 206 is defined by an outer surface 202, and is cylindrically symmetric about central axis 204. The body of capture element 206 is effectively formed as a surface 202 of revolution about axis 204. The body of capture element 206 can be formed from a variety of different materials, including various types of optical glass and/or crystalline materials. Specific examples of suitable materials include, but are not limited to, fused silica, sapphire, quartz, diamond, silicon, germanium, zinc selenide (ZnSe), zinc sulfide (ZnS), potassium bromide, potassium iodide, calcium fluoride, sodium chloride, sodium fluoride, barium fluoride, cesium bromide, cesium iodide, thallium bromide, thallium iodide, and thallium bromoiodide TlBrₓI₍₁₋ₓ₎ (where x=0 . . . 1).

As shown in the example of FIG. 2A, incident radiation 162—generated by first radiation source 102—enters capture element 206 through surface 208, reflects from surface 202, and passes through interface 232 to enter contact element 230. Reflected radiation 164 that has interacted with sample 150 enters capture element 206 from contact element 230 through interface 232 and is reflected by surface 202, emerging from capture element 206 to be directed to detector 112 by mirror 108 (as shown in FIG. 1). Incident radiation 166—generated by second radiation source 104 as shown in FIG. 1—also enters capture element 206 through surface 208. Incident radiation 166 is transmitted through interface 232 and interacts with sample 150. Emitted radiation 172 is transmitted through interface 232, passes through capture element 206 and is transmitted through surface 208, and is directed to detector 188 as shown in FIG. 1.

In some embodiments, surface 202 of capture element 206 has a linear cross-sectional shape, such that the body of capture element 206 has the shape of a truncated right-angled cone. In such embodiments, surface 202 functions in a manner similar to a planar mirror, reflecting incident and reflected radiation without providing substantial focusing or collimating of the radiation.

In certain embodiments, surface 202 of capture element 206 has a non-linear (e.g., curved) cross-sectional shape. In such embodiments, surface 202 functions both to reflect incident and reflected radiation, and to focus or de-focus the radiation. In general, a wide variety of different surfaces 202 can be used for such a purpose. In some embodiments, for example, surface 202 has a spherical curvature and functions effectively as a spherical mirror. In certain embodiments, surface 202 has a parabolic curvature and functions effectively as a parabolic mirror. In some embodiments, surface 202 has an elliptical curvature and effectively functions as an elliptical mirror. In certain embodiments, surface 202 has a hyperbolic curvature and effectively functions as a hyperbolic mirror.

FIG. 2B is a schematic diagram showing an example of a capture element 206 that includes surfaces 202 with a curved cross-sectional shape. As noted above, curved surfaces 202 can effectively function as mirrors that focus or collimate radiation, in addition to steering radiation to a location.

In some embodiments, the curvature of surface 202 is more complex (e.g., aspherical), and may be formed as continuously-connected regions of different radii of curvature. It should also be noted that in certain embodiments, surface 202 can be formed as a compound surface that includes combinations of surface segments with any of the different types of curvatures described above. The surface segments can be blended continuously or discontinuously (or a combination thereof) to form surface 202.

FIG. 2C is a schematic diagram showing an example of a capture element 206 that includes surfaces 202 formed as compound surfaces by two regions 202a and 202b of different radius of curvature. In FIG. 2C, regions 202a and 202b are continuously-connected to form a smooth surface 202. However, in some embodiments, the regions can be discontinuously connected. Further, while surfaces 202 in FIG. 2C are formed by blending two regions 202a and 202b of different curvature, it should be appreciated that more generally, surfaces 202 can be formed by blending any number of regions of different radius of curvature.

In certain embodiments, surface 202 is formed from a plurality of connected linear surface segments. Depending upon the number of such segments and their lengths, the connected linear surface segments may approximate the shape of a continuously curved surface (e.g., a surface with either a convex or concave curvature). More generally, in some embodiments, the connected linear surface segments can approximate surfaces having any regular or irregular curvature, and surfaces that can include regions of convex curvature, regions of concave curvature, and surfaces with both concave and convex curvature regions.

FIG. 2D is a schematic diagram showing an example of a capture element 206 that includes surfaces 202 formed from a plurality of linear surface segments 203 that approximate the shape of a continuously curved surface. The linear surface segments in the example of FIG. 2D are connected such that a plurality of vertices are formed in surface 202 where adjacent linear surface segments intersect. In general, any number of linear surface segments 203 can be used, with a greater number of linear surface segments generally better approximating a continuously curved surface.

In some embodiments, different linear surface segments 203 can have different reflectivities (e.g., by applying different coatings to the outer surfaces of the linear surface segments 203) to adjust the properties of the radiation that is reflected from surface 202. For example, the effective beam waist of the reflected radiation can be adjusted by applying coatings that reduce the amount of reflected radiation from locations on surface 202 that are further from the location of the local maximum of incident radiation on the surface. Modulation of the reflected radiation can also be achieved by selective application of different coatings to different portions of surface 202 in embodiments where surface 202 is continuously linear or formed from one or more different curved surface segments, as described above and below.

In some embodiments, surface 202 is formed as a compound surface that includes both linear and non-linear segments. For example, surface 202 can include a curved portion (e.g., any of the curved portions described above) that functions to both reflect and focus or defocus light, and one or more straight portions connected to the curved portion. In such embodiments, the curved portion effectively functions as an embedded focusing/defocusing mirror embedded in the surface 202 of capture element 206.

FIG. 2E is a schematic diagram showing an example of a capture element 206 with a compound surface 202 formed by a plurality of linear surface segments 202c and non-linear surface segments 202d. The non-linear surface segments 202d effectively function as embedded mirrors within surface 202.

It should be noted that in the preceding examples, non-linear (i.e., curved) segments of surface 202 are shown as having convex (i.e., outward) curvature with respect to the linear surfaces 202 of capture element 206 shown FIG. 2A. More generally, however, non-linear segments of surface 202 can also have concave curvature relative to the linear surfaces 202 of capture element 206 in FIG. 2A. Moreover, combinations of non-linear segments with convex and concave curvature can be used to form complex-curvature surfaces 202. Such complex-curvature surfaces 202 can be used for beam steering, collimation, focusing, and to adjust other properties of radiation that is reflected from or received by surfaces 202.

In certain embodiments, surface 202 can optionally include one or more reflective coatings that enhance the reflectivity of surface 202 for incident and/or reflected radiation. Suitable coatings include, but are not limited to, metal coatings formed of materials such as gold, aluminum, and silver, and dielectric multi-layer optical coatings. As discussed above, coatings can be selectively applied to different portions of surface 202 to modulate the properties of incident and/or reflected radiation. For example, the reflectivity of surface 202 can be modulated as a function of location along the surface through application of different coatings/coating thicknesses to control properties such as the effective beam waist and intensity distribution of radiation that interacts with the surface.

Contact element 230 is in contact with capture element 206 at interface 232 as described above, such that the two elements together effectively form a continuous optical component. As shown in FIG. 2A, in certain embodiments, the outer surfaces 202 and 234 are effectively contiguous and form an outer surface of the optical component that has no surface discontinuity or break at interface 232. In some embodiments, outer surfaces 202 and 234 may not be contiguous, such that a surface discontinuity is present at interface 232. The surface discontinuity can extend circumferentially around an entire perimeter of the optical element at interface 232, or may only be present at specific angular ranges or values relative to axis 204.

In some embodiments, contact element 230 and capture element 206 are formed from a common material to reduce reflective losses at interface 232 due to mismatches in refractive index. In certain embodiments, contact element 230 and capture element 206 are formed from different materials. The different materials can have different indices of refraction. In such embodiments, the index of refraction mismatch at wavelengths between 800 nm and 2000 nm can optionally be 0.2 or less (e.g., 0.17 or less, 0.15 or less, 0.13 or less, 0.1 or less, 0.07 or less, 0.05 or less) to reduce reflective losses at interface 232. Suitable materials from which contact element 230 is formed can include, for example, any of the materials described above in connection with capture element 206.

In some embodiments, as shown in FIG. 2A, surfaces of contact element 230 and capture element 206 are directly in contact to form interface 232. In certain embodiments, one or more additional layers or materials are disposed on a surface of contact element 230, on a surface of capture element 206, or on both surfaces, forming interface 232. For example, in some embodiments, a graded-index coating is applied to either or both of the surfaces of capture element 206 and/or contact element 230 that form interface 232. The graded-index coating has a refractive index that varies as a function of thickness within the coating, and can be used when capture element 206 and contact element 230 are formed from different materials. The graded-index coating can be used to bridge the refractive indices of the two elements to reduce reflections from interface 232 that might otherwise occur due to a sharp discontinuity in refractive index. Suitable graded-index coatings are described, for example, in U.S. Pat. Nos. 11,088,291, 9,590,133, 11,953,702, and 8,553,333, the entire contents of each of which are incorporated herein by reference.

Contact element 230 is generally rotationally symmetric about axis 204. In some embodiments, the outer surface 234 of contact element 230 has a linear cross-sectional profile. As such, the body of contact element 230—which is effectively formed as a surface 234 of revolution about axis 204—has the shape of a truncated right-angled cone. The truncated apical surface 236 functions as a sample contacting surface. During measurement of sample 150, as shown in FIG. 1, surface 236 is positioned in contact with, or in close proximity to, sample 150. Incident radiation 162 interacts with sample 150 through surface 236 and undergoes internal reflection at surface 236.

More generally, however, contact element 230 can have a wide variety of different cross-sectional profiles. In certain embodiments, for example, outer surface 234 can have a curved cross-sectional shape. The curvature of outer surface 234 can be regular (e.g., spherical, hyperbolic, parabolic, elliptical, or another regular curvature) or irregular (e.g., aspherical). Outer surface 234 can have a single curvature with respect to a reference datum, or can be more complex and formed as continuously connected regions of different radii of curvature. It should also be noted that in certain embodiments, surface 234 can be formed as a compound surface that includes combinations of surface segments with any of the different types of curvatures described above. The surface segments can be blended continuously or discontinuously (or a combination thereof) to form surface 234.

In certain embodiments, surface 234 is formed from a plurality of connected linear surface segments. Depending upon the number of such segments and their lengths, the connected linear surface segments may approximate the shape of a continuously curved surface (e.g., a surface with either a convex or concave curvature). More generally, in some embodiments, the connected linear surface segments can approximate surfaces having any regular or irregular curvature, and surfaces that can include regions of convex curvature, regions of concave curvature, and surfaces with both concave and convex curvature regions.

In general, the examples of surfaces 202 shown in FIGS. 2A-2E also apply to surface 234. Surface 234 can have a wide variety of different cross-sectional surface shapes by combining linear and/or non-linear regions of different shapes, blended continuously and/or discontinuously, to achieve a variety of complex surface profiles.

In some embodiments, contact element 230 has a shape corresponding to rotation of the cross-sectional profile of outer surface 234 about an axis (e.g., axis 204). That is, contact element 230 has cylindrical symmetry about the axis. In certain embodiments, contact element 230 is symmetric about an axis, but does not correspond to a shape formed by rotation of a cross-sectional profile of outer surface 234 about an axis. For example, contact element 230 can include a plurality (e.g., 3 or more, 4 or more, 5 or more, 6 or more, 8 or more, 10 or more, or even more) lateral surfaces that form facets, such that contact element 230 is effectively a prism. The lateral surfaces can be planar surfaces, curved surfaces, or compound surfaces formed as combinations of planar and curved surfaces. Curved surface regions of the lateral surfaces can have any of the combinations of different regular and irregular curvatures discussed above. Combinations of multiple planar surface regions can be used to form lateral surfaces, and multiple planar surface regions can be used to form a lateral surface that approximates a curved lateral surface. It should also be noted that in embodiments where contact element 230 has multiple lateral surfaces, some of the shapes of the lateral surfaces may differ from the shapes of other lateral surfaces; alternatively, in certain embodiments, all lateral surfaces have the same shape.

In some embodiments, capture element 206 includes an optional anti-reflection coating 210 disposed on a lower surface of the element. Anti-reflection coating 210 functions to reduce or eliminate reflection of incident radiation and/or reflected radiation as it passes through the surface 208 of capture element 206. For example, anti-reflection coating 210 can be implemented as a multi-layer dielectric coating, tuned for the wavelength band of the incident and reflected radiation.

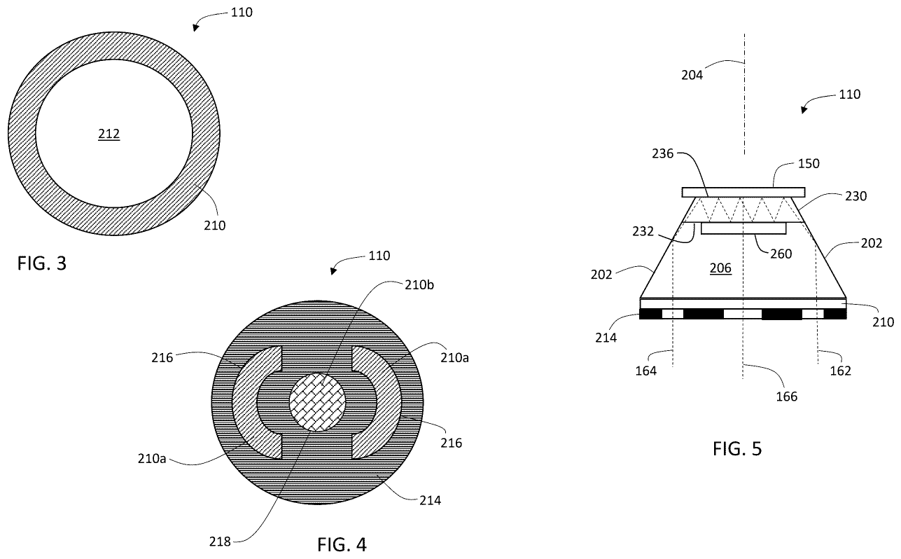

In certain embodiments, anti-reflection coating 210—if present—can be applied to an entire bottom surface 208 of capture element 206. Alternatively, in some embodiments, anti-reflection coating 210 can be applied to only portions of surface 208. FIG. 3 is a schematic diagram showing an example of a capture element 206 in which anti-reflection coating 210 is applied to an annular region of surface 208, leaving an uncoated aperture region 212 in the center of surface 208. In this configuration, the anti-reflection coating 210 is positioned to interact with incident radiation 162 and reflected radiation 164, but not with incident radiation 166 or reflected radiation 172.

More generally, anti-reflection coating 210 can be applied in a wide variety of patterns and/or to different portions of surface 208, depending upon the configuration of system 100 and the nature of the measurement information to be obtained for sample 150.

In some embodiments, more than one anti-reflection coating 210 can be applied to surface 208. Referring to FIG. 3 for example, in some embodiments, a first anti-reflection coating 210 can be applied in an annular configuration as shown. Further, a second anti-reflection coating can be applied within the aperture region 212 of surface 208, partially or completely covering the aperture region. The second anti-reflection coating can be different from the first anti-reflection coating, and can be selected to reduce or eliminate reflection of incident radiation 166 and/or emitted radiation 172 at surface 208. For system configurations in which more than two different measurement modalities are implemented, more than two different anti-reflection coatings 210 can be applied to surface 208, in different or even common regions of surface 208. In general, the number of different anti-reflection coatings 210 that can be applied to surface 210, irrespective of the number of different measurement modalities implemented in system 100, is 1 or more (e.g., 2 or more, 3 or more, 4 or more, 5 or more, 7 or more, or even more).

By way of example, for a system 100 that obtains both infrared absorbance/reflectance information and Raman scattering information for sample 150 as shown in the example of FIG. 1, two different anti-reflection coatings can be applied to surface 208. For mid-infrared absorbance/reflectance measurements, a first anti-reflection coating can be positioned in the annular region (e.g., anti-reflection coating 210) of surface 208 as shown in FIG. 3. The first anti-reflection coating can be selected to have an optical efficiency in a wavelength region from about 2.5 microns to about 25 microns. For Raman scattering measurements, a second anti-reflection coating can be positioned to cover some or all of the aperture region 212 in FIG. 3. Assuming a Raman excitation wavelength of 785 nm as an example, the second anti-reflection coating can be selected to have an optical efficiency in a wavelength region from about 800 nm to about 1100 nm, reflecting the downshifting of Raman scattered radiation relative to incident excitation radiation.

In some embodiments, capture element 206 optionally includes a mask 214 applied to a bottom surface of the capture element 206. In some embodiments, mask 214 is applied directly to surface 208 of the capture element body. In certain embodiments, mask 214 is applied to one or more anti-reflection coatings 210 on the capture element body. FIG. 4 is a schematic diagram showing a bottom surface of capture element 206. Two anti-reflection coatings are applied to surface 208 of capture element 206. A first anti-reflection coating 210a is applied to an annular region of surface 208, as shown in FIG. 3 and described above. A second anti-reflection coating 210b is applied to a central region of surface 208.

Mask 214 is applied over the anti-reflection coatings in FIG. 4 and includes apertures that function to isolate the optical pathways corresponding to different measurement modalities. Apertures 216 isolate the optical pathways for incident radiation 162 and reflected radiation 164, corresponding to infrared reflectance/absorbance measurements for sample 150. Aperture 218 isolates the optical pathways for incident radiation 166 and emitted radiation 172, corresponding to Raman scattering measurements for sample 150.

In general, the shapes of apertures (e.g., apertures 216 and 218) and the locations of the apertures relative to surface 208 can be selected as desired based on the measurement configuration of system 100. Apertures can be formed with regular cross-sectional shapes (e.g., circles, squares, rectangles, n-sided polygons) or more complex regular shapes such as the semi-annular apertures 216 shown in FIG. 4. The number of apertures can generally be selected as desired based on the optical pathways of incident and reflected/emitted radiation to and from the sample, and the number of measurement modalities implemented by system 100.

Mask 214 can generally be formed from any of a variety of materials that are optically opaque within relevant wavelength bands for the measurement modalities implemented in system 100. Suitable materials include, but are not limited to, metals such as aluminum, silver, gold, nickel, and stainless steel, plastics, and a variety of single-layer and multi-layer dielectric materials.

In certain embodiments, coupling element 110 can be configured to implement multiple interactions between incident radiation and sample 150. By inducing multiple interactions, the intensity of observed measurement signals can be increased, thereby effectively increasing the signal-to-noise ratio of system 100. For example, for infrared absorbance/reflectance measurements such as those described in the examples above, coupling element 110 can be configured to direct incident radiation 162 to interact with sample 150 multiple times, thereby enhancing perturbations to the incident radiation arising from sample 150, and making such changes easier to detect.

Multiple interactions between incident radiation and sample 150 can be induced through a variety of different configurations of coupling element 110. FIG. 5 is a schematic diagram showing an example of such a configuration of coupling element 110. In FIG. 5, coupling element 110 includes a capture element 206 with a recess 260 formed in an upper surface of the body of capture element 206. Outer surface 202 of capture element 206 is shaped and oriented to direct incident radiation 162 to a location at surface 236 of contact element 230 that is displaced laterally from the central axis of coupling element 110. Upon reflection from surface 236, the reflected radiation does not couple into capture element 206 from contact element 230 due to the air gap caused by recess 260. Instead, the reflected radiation reflects from the bottom surface of contact element 230 and propagates back to upper surface 236, where it undergoes another interaction with sample 150. Depending upon the thickness and diameter of contact element 230, multiple interactions between radiation back-reflected from the bottom surface of contact element 230 and sample 150 can be induced. Reflected radiation 164 that is eventually coupled into capture element 206 and out of coupling element 110 is encoded with sample absorption information according to the multiple interactions with sample 150.

As another example, in some embodiments, a reflective coating can be disposed over a portion of interface 232 between capture element 206 and contact element 230 to induce multiple interactions between incident radiation 162 and sample 150 by reflecting radiation back toward the sample. For example, the reflective coating can be disposed over a central region of interface 232, and surface 202 of capture element 206 can be shaped and oriented to direct incident radiation 162 to a location at surface 236 of contact element 230 that is displaced laterally from the central axis of coupling element 110. Upon reflection from surface 236, the reflected radiation does not couple into capture element 206 from contact element 230 due to the reflective coating at interface 232. Instead, the reflected radiation is back-reflected by the reflective coating and propagates back to upper surface 236, where it undergoes another interaction with sample 150. Depending upon the diameter and thickness of contact element 230, multiple interactions between the radiation and sample 150 can be induced before the reflected radiation is coupled into capture element 206 and out of coupling element 110.

Reflective coatings suitable for inducing multiple interactions between incident radiation 162 and sample 150 can be formed from a wide variety of materials. Such materials include, but are not limited to, metals such as gold, aluminum, and silver, and dielectric coating materials.

As shown in FIG. 5, surface 236 is a planar surface from which incident radiation 162 reflects multiple times before emerging from contact element 230 as reflected radiation 164. In some embodiments, surface 236 can be formed from multiple planar surface segments, such that surface 236 effectively approximates a non-planar surface shape. In certain embodiments, surface 236 can be formed as a curved surface having a single radius or type of curvature, or alternatively, formed from multiple curved surface segments that are blended to form a more complex curved surface. Curved surfaces and surface segments can have shapes that correspond to any of the regular curvatures (e.g., spherical, hyperbolic, parabolic, elliptical) described above, and can also have irregular (e.g., aspherical) curvatures.

A number of advantages can be realized by using a non-planar surface 236. In some embodiments, for example, a non-planar surface 236 achieves superior contact with a sample having a non-planar surface topology. As a result, incident radiation 162 can interact more extensively with the sample, providing a greater signal-to-noise ratio in measurement data.

In certain embodiments, the shape of surface 236 can be selected to further increase the number of round trips of incident radiation 162 between surface 236 and interface 232. For example, a more complex shape of surface 236 may allow for more round trips than a planar surface, thereby providing a greater signal-to-noise ratio in measurement data.

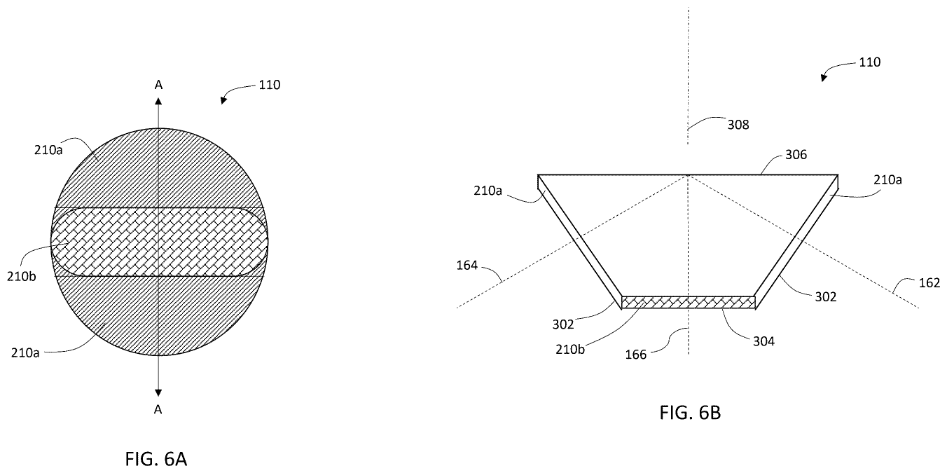

In FIG. 2A, coupling element 110 includes two elements: capture element 206 and coupling element 230. In some embodiments, however, coupling element 110 is implanted as a one-piece element with a unitary body. An example of such a coupling element is shown in FIGS. 6A and 6B.

FIG. 6A is a schematic bottom view of an example of a coupling element 110, and FIG. 6B is a schematic view taken along section line A-A in FIG. 6A of the coupling element. Coupling element 110 in FIGS. 6A and 6B is symmetric about a plane containing central axis 308 and implemented as a truncated cylindrical body, with angled lateral surfaces 302 and a bottom surface 304 orthogonal to axis 308. A contact window 240 is optionally present in coupling element 110. A first anti-reflection coating 210a is disposed on surfaces 302, and a second anti-reflection coating 201b is disposed on surface 304.

The body of coupling element 110 can be formed of any of the materials described above in connection with capture body 206. The anti-reflection coatings 210a and 210b can be formed of any of the anti-reflection coating materials described previously.

Incident radiation 162 is introduced at a first location on lateral surface 302, interacts with sample 150 at an upper surface 306 of coupling element 110 (or at a surface of contact window 240), and reflected radiation 164 is coupled out of coupling element 110 at a second location on lateral surface 302. Incident radiation 166 is introduced through bottom surface 304, interacts with sample 150 at surface 306, and emitted radiation propagates from sample 150 through coupling element 110, and is transmitted through surface 304.

In FIG. 6B, lateral surfaces 302 are shown as planar surfaces. More generally, however, lateral surfaces 302 can be implemented in a wide variety of configurations. In certain embodiments, for example, lateral surface 302 can have a curved cross-sectional shape. The curvature of lateral surface 302 can be regular (e.g., spherical, hyperbolic, parabolic, elliptical, or another regular curvature) or irregular (e.g., aspherical). Lateral surface 302 can have a single curvature with respect to a reference datum, or can be more complex and formed as continuously connected regions of different radii of curvature. It should also be noted that in certain embodiments, surface 302 can be formed as a compound surface that includes combinations of surface segments with any of the different types of curvatures described above. The surface segments can be blended continuously or discontinuously (or a combination thereof) to form surface 302.

In certain embodiments, surface 302 is formed from a plurality of connected linear surface segments. Depending upon the number of such segments and their lengths, the connected linear surface segments may approximate the shape of a continuously curved surface (e.g., a surface with either a convex or concave curvature). More generally, in some embodiments, the connected linear surface segments can approximate surfaces having any regular or irregular curvature, and surfaces that can include regions of convex curvature, regions of concave curvature, and surfaces with both concave and convex curvature regions.

Thus, lateral surfaces 302 can be planar surfaces, curved surfaces, or compound surfaces formed as combinations of planar and curved surfaces. Curved surface regions of the lateral surfaces can have any of the combinations of different regular and irregular curvatures discussed above. Combinations of multiple planar surface regions can be used to form lateral surfaces, and multiple planar surface regions can be used to form a lateral surface that approximates a curved lateral surface. It should also be noted that some of the shapes of the lateral surfaces 302 may differ from the shapes of other lateral surfaces; alternatively, in certain embodiments, all lateral surfaces 302 have the same shape.

Non-planar lateral surfaces 302 can have a variety of applications. In some embodiments, for example, curved lateral surfaces 302 can be used to focus incident radiation 162 onto a sample in contact with surface 306. In certain embodiments, curved lateral surfaces 302 can be used to collect reflected radiation from surface 306.

It should be appreciated that in embodiments where coupling element 110 is formed from a unitary one-piece body, the surfaces of the unitary body (i.e., the surfaces that are equivalent to surfaces 202 and 234) can have the same shapes, coatings, and configurations as described above for surfaces 202 and 234, and can include some or all of the features described in connection with the various examples of surfaces 202 and 234.

In FIG. 6B, surface 306 is shown as a planar surface. More generally, however, surface 306 can have a variety of shapes. In some embodiments, surface 306 can be formed from multiple planar surface segments, such that surface 306 effectively approximates a non-planar surface shape. In certain embodiments, surface 306 can be formed as a curved surface having a single radius or type of curvature, or alternatively, formed from multiple curved surface segments that are blended to form a more complex curved surface. Curved surfaces and surface segments can have shapes that correspond to any of the regular curvatures (e.g., spherical, hyperbolic, parabolic, elliptical) described above, and can also have irregular (e.g., aspherical) curvatures.

A number of advantages can be realized by using a non-planar surface 306. For example, as discussed above, a non-planar surface can, in some circumstances, achieve superior contact with a sample having a non-planar surface topology. As a result, incident radiation 162 can interact more extensively with the sample, providing a greater signal-to-noise ratio in measurement data.

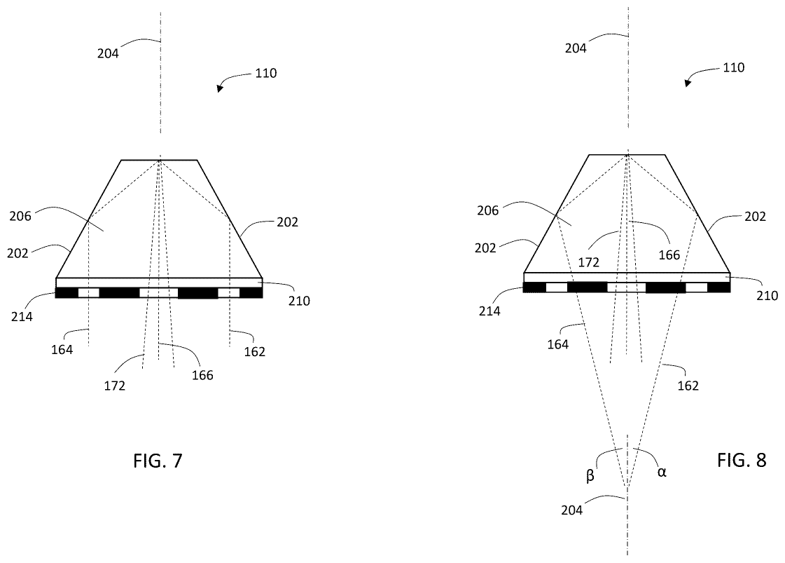

Another example of a unitary body coupling element 110 is shown in FIG. 7. The body of coupling element 110 essentially corresponds to the combined bodies of capture element 206 and contact element 230 in FIG. 2A. Coupling element 110 in FIG. 7 can also optionally include anti-reflection coating(s) 210 and mask 214, all of which can be implemented in a manner similar to features described above.

In some embodiments, the measurement systems described herein are configured to direct incident radiation 162 to enter coupling element 110 along a direction that is nominally parallel to axis 204. This geometry can facilitate optical alignment of coupling element 110 with other components of the measurement systems. However, as shown in FIG. 8, in certain embodiments, incident radiation 162 enters coupling element 110 at a non-zero angle α relative to axis 204. Directing incident radiation to enter coupling element 110 at such an angle can facilitate different types of spatial illumination and control of incident radiation 162 by coupling element 110. In general, the angle α can be between 0 degrees and 60 degrees (e.g., between 0 degrees and 55 degrees, between 0 degrees and 50 degrees, between 0 degrees and 45 degrees, between 0 degrees and 40 degrees, between 0 degrees and 35 degrees, between 0 degrees and 30 degrees, between 0 degrees and 25 degrees, between 0 degrees and 20 degrees, between 0 degrees and 15 degrees, between 0 degrees and 10 degrees, or any range of angles within any of the foregoing ranges).

In certain embodiments, reflected radiation 164 emerges from coupling element 110 in a direction that is nominally parallel to axis 204. For example, in embodiments where coupling element 110 is rotationally symmetric about axis 204 and incident radiation 162 enters coupling element 110 in a direction parallel to axis 204, reflected radiation 164 may emerge from coupling element 110 in a direction that is also parallel to axis 204.

More generally however as shown in FIG. 8, reflected radiation 164—depending upon the configuration of the surfaces of coupling element 110 and the angle α at which incident radiation 162 enters coupling element 110—can emerge from coupling element 110 at an angle β relative to axis 204. The angle β may be the same as or different from the angle α, depending upon the symmetry of coupling element 110 relative to the direction of incidence α and the configuration of coupling element 110. In general, the angle β can be between 0 degrees and 60 degrees (e.g., between 0 degrees and 55 degrees, between 0 degrees and 50 degrees, between 0 degrees and 45 degrees, between 0 degrees and 40 degrees, between 0 degrees and 35 degrees, between 0 degrees and 30 degrees, between 0 degrees and 25 degrees, between 0 degrees and 20 degrees, between 0 degrees and 15 degrees, between 0 degrees and 10 degrees, or any range of angles within any of the foregoing ranges).

### OTHER EMBODIMENTS

While this disclosure describes specific implementations, these should not be construed as limitations on the scope of the disclosure, but rather as descriptions of features in certain embodiments. Features that are described in the context of separate embodiments can also generally be implemented in combination in a single embodiment. Conversely, various features that are described in the context of a single embodiment can also be implemented in multiple embodiments separately or in any suitable sub-combination. Moreover, although features may be described above as present in certain combinations and even initially claimed as such, one or more features from a claimed combination can generally be excised from the combination, and the claimed combination may be directed to a sub-combination or variation of a sub-combination.

In addition to the embodiments expressly disclosed herein, it will be understood that various modifications to the embodiments described may be made without departing from the spirit and scope of the disclosure. Accordingly, other embodiments are within the scope of the following claims.

What is claimed is:

1. An optical element, comprising:
a capture element having cylindrical symmetry with respect to a central axis of the capture element and comprising an outer surface formed as a surface of revolution about the central axis;
a coupling element that contacts the capture element and comprises a central axis that is collinear with the central axis of the capture element; and
a mask disposed on or adjacent to a surface of the capture element, and comprising a plurality of apertures that define entrance and exit apertures for radiation into and out of the optical element,
wherein the capture element, coupling element, and mask are configured to define two different optical excitation pathways in the optical element through two different apertures of the plurality of apertures; and
wherein the two different optical excitation pathways end at a common location at a surface of the coupling element.

2. The optical element of claim 1, wherein the capture element is formed as a truncated cone.

3. The optical element of claim 1, wherein the surface of revolution that forms the outer surface of the capture element is a linear surface.

4. The optical element of claim 1, wherein the surface of revolution that forms the outer surface comprises a plurality of linear segments.

5. The optical element of claim 1, wherein the surface of revolution that forms the outer surface comprises a curved surface.

6. The optical element of claim 5, wherein the curved surface has a parabolic curvature.

7. The optical element of claim 5, wherein the curved surface has a hyperbolic curvature.

8. The optical element of claim 5, wherein the curved surface has a spherical curvature.

9. The optical element of claim 5, wherein the curved surface has an elliptical curvature.

10. The optical element of claim 1, wherein the surface of revolution that forms the outer surface comprises a curved surface portion and at least one linear surface portion.

11. The optical element of claim 10, wherein the curved surface portion and the at least one linear surface portion form a contiguous surface of revolution.

12. The optical element of claim 5, wherein the curved surface has a compound curvature formed by a plurality of curved surface regions of different curvature.

13. The optical element of claim 1, wherein the capture element is formed from at least one material selected from the group consisting of: diamond, silicon, germanium, zinc selenide, zinc sulfide, glass, quartz, potassium iodide, potassium bromide, calcium fluoride, sodium chloride, sodium fluoride, barium fluoride, cesium iodide, cesium bromide, thallium bromide, thallium iodide, and TlBrₓI₁₋ₓ, wherein x is in a range between 0 and 1.

14. The optical element of claim 1, wherein the coupling element comprises an outer surface, and wherein the outer surfaces of the capture element and the contact element form a contiguous outer surface of the optical element.

15. The optical element of claim 1, wherein the coupling element is symmetric about the central axis of the coupling element.

16. The optical element of claim 1, wherein the coupling element comprises an outer surface formed from a plurality of planar surface segments arranged symmetrically about the central axis of the coupling element.

17. The optical element of claim 1, wherein the coupling element is a prism.

18. The optical element of claim 1, wherein the coupling element comprises an outer surface formed as a surface of revolution about the central axis of the coupling element.

19. The optical element of claim 18, wherein the surface of revolution that forms the outer surface of the coupling element is a linear surface.

20. The optical element of claim 18, wherein the surface of revolution that forms the outer surface of the coupling element comprises a plurality of linear segments.

21. The optical element of claim 18, wherein the surface of revolution that forms the outer surface of the coupling element comprises a curved surface.

22. The optical element of claim 21, wherein the curved surface of the outer surface of the coupling element has a parabolic curvature.

23. The optical element of claim 21, wherein the curved surface of the outer surface of the coupling element has a hyperbolic curvature.

24. The optical element of claim 21, wherein the curved surface of the outer surface of the coupling element has a spherical curvature.

25. The optical element of claim 21, wherein the curved surface of the outer surface of the coupling element has an elliptical curvature.

26. The optical element of claim 18, wherein the surface of revolution that forms the outer surface of the coupling element comprises a curved surface portion and at least one linear surface portion.

27. The optical element of claim 26, wherein the curved surface portion and the at least one linear surface portion of the surface of revolution that forms the outer surface of the coupling element form a contiguous surface of revolution.

28. The optical element of claim 21, wherein the curved surface of the surface of revolution that forms the outer surface of the coupling element has a compound curvature formed by a plurality of curved surface regions of different curvature.

29. The optical element of claim 1, wherein the coupling element is formed from at least one material selected from the group consisting of: diamond, silicon, germanium, zinc selenide, zinc sulfide, glass, quartz, potassium iodide, potassium bromide, calcium fluoride, sodium chloride, sodium fluoride, barium fluoride, cesium bromide, cesium iodide, thallium bromide, thallium iodide, and TlBrₓI₁₋ₓ, wherein x is in a range between 0 and 1.

30. The optical element of claim 1, wherein the mask is positioned on or adjacent to a surface of the capture element that is opposite to a surface of the capture element that contacts the coupling element.

31. The optical element of claim 30, wherein:
the mask defines a first aperture and first optical path for illumination light within the optical element; and
the central axis of capture element is not within the first aperture.

32. The optical element of claim 31, wherein the first aperture is positioned so that illumination light propagating along the first optical path in a direction parallel to the central axis of the capture element will be incident on the outer surface of the capture element from within the capture element.

33. The optical element of claim 31, wherein:
the mask defines a second aperture and second optical path for illumination light within the optical element; and
the central axis of the capture element is within the second aperture.

34. The optical element of claim 33, wherein the second aperture is positioned so that illumination light propagating along the second optical path in a direction parallel to the central axis of the capture element will not be incident on the outer surface of the capture element from within the capture element.

35. The optical element of claim 34, wherein the second aperture is positioned so that illumination light propagating along the second optical path in a direction parallel to the central axis of the capture element will be incident on an interface between the capture element and the coupling element.

36. The optical element of claim 34, wherein:
the coupling element comprises a contact surface positioned opposite a surface of the coupling element that contacts the capture element; and
the second aperture is positioned so that illumination light propagating along the second optical path in a direction parallel to the central axis of the capture element will be incident on the contact surface.

37. The optical element of claim 36, wherein the second aperture is positioned so that light emitted from a sample that contacts the contact surface of the coupling element emerges from the optical element through the second aperture.

38. The optical element of claim 37, wherein:
the mask defines a third aperture and third optical path for reflected light within the optical element; and
the central axis of the capture element is not within the third aperture.

39. The optical element of claim 38, wherein the third aperture is positioned so that light reflected from the contact surface of the coupling element and from the outer surface of the capture element emerges from the optical element through the third aperture.

40. The optical element of claim 39, wherein the first and third apertures have a common shape in a plane defined by the surface of the capture element on which or adjacent to which the mask is disposed.

41. The optical element of claim 39, wherein the first, second, and third apertures have a common shape in a plane defined by the surface of the capture element on which or adjacent to which the mask is disposed.

42. The optical element of claim 39, wherein the first and third apertures are a common, ring-shaped aperture that is symmetric about the central axis of the capture element.

43. The optical element of claim 39, wherein at least one of the first and third apertures is an arc-shaped aperture.

44. The optical element of claim 43, wherein a center of curvature of the arc-shaped aperture coincides with a center of the surface of the capture element on which or adjacent to which the mask is disposed.

45. The optical element of claim 43, wherein the central axis of the capture element extends through the center of curvature of the arc-shaped aperture.

46. The optical element of claim 39, wherein the central axis of the capture element extends through a center of the second aperture.

47. The optical element of claim 46, wherein the second aperture is symmetric about the central axis of the capture element.

48. The optical element of claim 39, wherein the second aperture is circular in shape.

49. The optical element of claim 1, further comprising a reflective coating positioned on at least a portion of the outer surface of the capture element.

50. The optical element of claim 1, further comprising an anti-reflection coating positioned between the mask and the surface of the capture element on which the mask is disposed or to which the mask is adjacent.

51. The optical element of claim 50, wherein the anti-reflection coating comprises a plurality of dielectric material layers.

52. The optical element of claim 50, wherein the anti-reflection coating comprises:
a first coating material having a first anti-reflection spectral band, positioned so that the first coating material is aligned with at least one of the plurality of apertures; and
a second coating material having a second anti-reflection spectral band that is different from the first anti-reflection spectral band, and positioned so that the second coating material is aligned with a different at least one of the plurality of apertures.

53. The optical element of claim 1, further comprising a reflective surface positioned at an interface between the capture element and the coupling element.

54. The optical element of claim 53, wherein the reflective surface comprises a reflective coating disposed on at least one of a surface of the capture element and a surface of the coupling element.

55. The optical element of claim 53, wherein the reflective surface does not extend fully across the interface between the capture element and the coupling element.

56. The optical element of claim 55, wherein the reflective surface defines a fourth aperture positioned so that illumination light that reflects from the outer surface of the capture element is not incident on the reflective surface.

57. The optical element of claim 55, wherein the reflective surface defines a fifth aperture positioned so that illumination light that propagates along the central axis of the capture element is not incident on the reflective surface.

58. The optical element of claim 55, wherein the reflective surface is positioned so that illumination light that reflects from a surface of the coupling element that is opposite to the interface also reflects from the reflective surface.

59. The optical element of claim 58, wherein the reflective surface is positioned so that illumination light reflects multiple times from the surface of the coupling element that is opposite to the interface and from the reflective surface.

60. The optical element of claim 1, further comprising a recess formed in a surface of the capture element.

61. The optical element of claim 60, wherein the recess does not extend fully across the interface between the capture element and the coupling element.

62. The optical element of claim 61, wherein the recess defines a fourth aperture positioned so that illumination light that reflects from the outer surface of the capture element enters the coupling element without being incident on the recess.

63. The optical element of claim 61, wherein the recess defines a fifth aperture positioned so that illumination light that propagates along the central axis of the capture element passes through the recess.

64. The optical element of claim 60, wherein the recess is positioned so that illumination light reflects multiple times from the surface of the coupling element that is opposite to the interface and from the surface of the coupling element that contacts the capture element.

65. A measurement system, comprising:
the optical element of any one of claims 1-59;
a first radiation source;
a second radiation source;
a first detector; and
a second detector,
wherein the optical element is positioned relative to the first and second radiation sources such that during operation of the measurement system, when the optical element is in contact with a sample:
the first radiation source generates first incident radiation that enters the optical element through a first aperture of the plurality of apertures and is incident at a location on the sample;
the second radiation source generates second incident radiation that enters the optical element through a second aperture of the plurality of apertures and is incident at the location on the sample;
the first detector is positioned to receive first emitted radiation through a third aperture of the plurality of apertures in response to an interaction between the sample and the first incident radiation; and
the second detector is positioned to receive second emitted radiation through the second aperture in response to an interaction between the sample and the second incident radiation.

66. The system of claim 65, wherein the first radiation source is configured to generate first incident radiation that is at least partially absorbed by the sample.

67. The system of claim 65, wherein the second radiation source is configured to generate second incident radiation that induces the sample to emit the second emitted radiation.

68. The system of claim 67, wherein the second incident radiation induces the sample to emit scattered light as the second emitted radiation.

69. The system of claim 68, wherein the scattered light comprises Raman scattered light.

70. The system of claim 67, wherein the second incident radiation induces the sample to emit fluorescence as the second emitted radiation.

71. The system of claim 65, wherein the second radiation source is configured to generate the second incident radiation with a full-width at half-maximum (FWHM) spectral bandwidth of 10 nm or less.

72. The system of claim 65, wherein the second radiation source is configured to generate the second incident radiation with a central wavelength of between 200 nm and 1600 nm.

73. The system of claim 65, wherein the first radiation source is configured to generate the first incident radiation with a full-width at half-maximum (FWHM) spectral bandwidth of 10 nm or more.

74. The system of claim 65, wherein the first radiation source is configured to generate the first incident radiation with a central wavelength of between 600 nm and 50,000 nm.

75. The system of claim 65, wherein the first radiation source comprises an interferometer.

76. The system of claim 65, wherein the first detector is configured to spectrally resolve the first emitted radiation.

77. The system of claim 66, wherein the second detector is configured to spectrally resolve the second emitted radiation.

78. A sample measurement method, comprising:
directing first incident radiation through the optical element of any one of claims 1-64 to be incident at a location on a sample, and measuring first emitted radiation generated in response to the first incident radiation and emerging from the optical element; and
directing second incident radiation through the optical element to be incident at the location on the sample, and measuring second emitted radiation generated in response to the second incident radiation and emerging from the optical element,
wherein the first emitted radiation comprises first incident radiation reflected from a surface of the optical element in contact with the sample, and wherein the second emitted radiation comprises radiation emitted from the sample through the surface of the optical element.

79. The method of claim 78, wherein the first incident radiation is at least partially absorbed by the sample.

80. The method of claim 78, wherein the second incident radiation induces the sample to emit the second emitted radiation.

81. The method of claim 80, wherein the second incident radiation induces the sample to emit scattered light as the second emitted radiation.

82. The method of claim 81, wherein the scattered light comprises Raman scattered light.

83. The method of claim 80, wherein the second incident radiation induces the sample to emit fluorescence as the second emitted radiation.

84. The method of claim 78, wherein the second incident radiation has a full-width at half-maximum (FWHM) spectral bandwidth of 10 nm or less.

85. The method of claim 78, wherein the second incident radiation has a central wavelength of between 200 nm and 1600 nm.

86. The method of claim 78, wherein the first incident radiation has a full-width at half-maximum (FWHM) spectral bandwidth of 10 nm or more.

87. The method of claim 78, wherein the first incident radiation has a central wavelength of between 600 nm and 50,000 nm.

88. The method of claim 78, wherein measuring the first emitted radiation comprises spectrally resolving the first emitted radiation.

89. The method of claim 78, wherein measuring the second emitted radiation comprises spectrally resolving the second emitted radiation.

90. An optical element, comprising:
a first planar surface configured to contact a sample;
a second planar surface opposite the first planar surface;
a first lateral surface oriented at an angle to the first and second planar surfaces;
a second lateral surface oriented at an angle to the first and second planar surfaces; and
an anti-reflection coating disposed on at least a portion of the second planar surface.

91. The optical element of claim 90, wherein the optical element is formed as a truncated prism.

92. The optical element of claim 90, wherein the optical element is formed as a truncated cone.

93. The optical element of claim 90, comprising a central axis about which the optical element is symmetric.

94. The optical element of claim 93, wherein the optical element is rotationally symmetric about the central axis.

95. The optical element of claim 94, wherein the optical element comprises an outer surface formed as a surface of revolution about the central axis.

96. The optical element of claim 95, wherein the surface of revolution that forms the outer surface of the capture element is a linear surface.

97. The optical element of claim 95, wherein the surface of revolution that forms the outer surface comprises a plurality of linear segments.

98. The optical element of claim 95, wherein the surface of revolution that forms the outer surface comprises a curved surface.

99. The optical element of claim 98, wherein the curved surface has a parabolic curvature.

100. The optical element of claim 98, wherein the curved surface has a hyperbolic curvature.

101. The optical element of claim 98, wherein the curved surface has a spherical curvature.

102. The optical element of claim 98, wherein the curved surface has an elliptical curvature.

103. The optical element of claim 95, wherein the surface of revolution that forms the outer surface comprises a curved surface portion and at least one linear surface portion.

104. The optical element of claim 103, wherein the curved surface portion and the at least one linear surface portion form a contiguous surface of revolution.

105. The optical element of claim 103, wherein the curved surface portion has a compound curvature formed by a plurality of curved surface regions of different curvature.

106. The optical element of claim 90, wherein the optical element is formed from at least one material selected from the group consisting of: diamond, silicon, germanium, zinc selenide, zinc sulfide, glass, quartz, potassium iodide, potassium bromide, calcium fluoride, sodium chloride, sodium fluoride, barium fluoride, cesium bromide, cesium iodide, thallium bromide, thallium iodide, and TlBrₓI₁₋ₓ, wherein x is in a range between 0 and 1.

107. The optical element of claim 90, wherein the anti-reflection coating comprises a plurality of dielectric material layers.

108. A measurement system, comprising:
the optical element of any one of claims 90-107;
a first radiation source;
a second radiation source;
a first detector; and
a second detector,
wherein the optical element is positioned relative to the first and second radiation sources such that during operation of the measurement system, when the optical element is in contact with a sample:
the first radiation source generates first incident radiation that enters the optical element through the first lateral surface and is incident at a location on the sample;
the second radiation source generates second incident radiation that enters the optical element through the second planar surface and is incident at the location on the sample;
the first detector is positioned to receive first emitted radiation through the second lateral surface in response to an interaction between the sample and the first incident radiation; and
the second detector is positioned to receive second emitted radiation through the second planar surface in response to an interaction between the sample and the second incident radiation.

109. The system of claim 108, wherein the first radiation source is configured to generate first incident radiation that is at least partially absorbed by the sample.

110. The system of claim 108, wherein the second radiation source is configured to generate second incident radiation that induces the sample to emit the second emitted radiation.

111. The system of claim 110, wherein the second incident radiation induces the sample to emit scattered light as the second emitted radiation.

112. The system of claim 111, wherein the scattered light comprises Raman scattered light.

113. The system of claim 108, wherein the second incident radiation induces the sample to emit fluorescence as the second emitted radiation.

114. The system of claim 108, wherein the second radiation source is configured to generate the second incident radiation with a full-width at half-maximum (FWHM) spectral bandwidth of 10 nm or less.

115. The system of claim 108, wherein the second radiation source is configured to generate the second incident radiation with a central wavelength of between 200 nm and 1600 nm.

116. The system of claim 108, wherein the first radiation source is configured to generate the first incident radiation with a full-width at half-maximum (FWHM) spectral bandwidth of 10 nm or more.

117. The system of claim 108, wherein the first radiation source is configured to generate the first incident radiation with a central wavelength of between 600 nm and 50,000 nm.

118. The system of claim 108, wherein the first radiation source comprises an interferometer.

119. The system of claim 108, wherein the first detector is configured to spectrally resolve the first emitted radiation.

120. The system of claim 108, wherein the second detector is configured to spectrally resolve the second emitted radiation.

121. A sample measurement method, comprising:
directing first incident radiation through the first lateral surface of the optical element of any one of claims 90-107 to be incident at a location on a sample, and measuring first emitted radiation generated in response to the first incident radiation and emerging from the second lateral surface of the optical element; and
directing second incident radiation through the optical element to be incident at the location on the sample, and measuring second emitted radiation generated in response to the second incident radiation and emerging from the optical element through the second planar surface,
wherein the first emitted radiation comprises first incident radiation reflected from the first planar surface of the optical element in contact with the sample, and wherein the second emitted radiation comprises radiation emitted from the sample through the first planar surface of the optical element.

122. The method of claim 121, wherein the first incident radiation is at least partially absorbed by the sample.

123. The method of claim 121, wherein the second incident radiation induces the sample to emit the second emitted radiation.

124. The method of claim 123, wherein the second incident radiation induces the sample to emit scattered light as the second emitted radiation.

125. The method of claim 124, wherein the scattered light comprises Raman scattered light.

126. The method of claim 123, wherein the second incident radiation induces the sample to emit fluorescence as the second emitted radiation.

127. The method of claim 121, wherein the second incident radiation has a full-width at half-maximum (FWHM) spectral bandwidth of 10 nm or less.

128. The method of claim 121, wherein the second incident radiation has a central wavelength of between 200 nm and 1600 nm.

129. The method of claim 121, wherein the first incident radiation has a full-width at half-maximum (FWHM) spectral bandwidth of 10 nm or more.

130. The method of claim 121, wherein the first incident radiation has a central wavelength of between 600 nm and 50,000 nm.

131. The method of claim 121, wherein measuring the first emitted radiation comprises spectrally resolving the first emitted radiation.

132. The method of claim 121, wherein measuring the second emitted radiation comprises spectrally resolving the second emitted radiation.
